(19) United States
(12) Patent Application Publication
(10) Pub. No.: US 2004/0202521 A1
(43) Pub. Date: Oct. 14, 2004

(54) Shear coupling

(76) Inventor: Karel Bostik, Edmonton (CA)

Correspondence Address: Karel BOSTIK, 15116 - 86 Street, EDMONTON, AB, T5E 5X6, CA

(21) Appl. No.: 10/806,360

(22) Filed: Mar. 23, 2004

(30) Foreign Application Priority Data
Apr. 11, 2003 (CA) 2,425,091

(51) Int. Cl. F16B 31/00

(52) U.S. Cl. 411/2

(57) ABSTRACT

Shear coupling is provided for connecting a downhole pump with the terminal member of a sucker rod string. The coupling is threadably connected to the sucker rod and the pump during normal operations, but can relatively easily be parted, if the pump becomes stuck, by pulling up on the still free sucker rod string. One end of the coupling has a pin incorporating an externally threaded head and the other end has an internally threaded cavity. A cylindrical, hollow body joining both ends is weakened by the groove, providing a stress concentration point, where the coupling will part, when exposed to predetermined desired load. The weakened part of the shear coupling is protected with a special coating, preventing corrosion and abrasion.

### STATEMENT REGARDING FEDERALLY SPONSORED RESEARCH OR DEVELOPMENT

Not Applicable.

### FIELD OF THE INVENTION

The present invention relates to sucker rod components and oil well tools, assuring that if a well string parts under certain conditions it will be in the most desirable place.

### BACKGROUND OF THE INVENTION

In the typical producing oil well, a pump is secured to the lower end of a sucker rod string and is vertically oscillated by means of pumping equipment of the walking beam type or rotated in case of progressive cavity pump. There are occasions when the pump will become logged or stuck in the well. For example, this may be caused by sand contained in the produced fluid, settling on top of the pump. If during removal of the pump, the sucker rod string should part between the upper and lower ends thereof, it is necessary for the upper portion of the sucker rod string to be first removed from the well, and then to conduct fishing operations to retrieve the lower portion of the sucker rod string and the pump at the lower end thereof It has been found desirable to provide a shear coupling, which will shear upon a predetermined amount of stress being applied by the string. A shear coupling placed at the lower end of the sucker rod string, allows for easier removal of the entire string.

In the past, shear couplings have been provided, [U.S. Pat. No. 4,459,060, U.S. Pat. No. 4,422,508, U.S. Pat. No. 2,889,162, CAp.1185591, CAp.1298715, CAp.2144364], which included a shear portion designed to shear upon predetermined stress applied by the sucker rod. Most of those devices comprise large number of parts, thus are expensive to manufacture and with exemption of those using protective sleeve and o-rings, are prone to corrosion. Some wells produce a corrosive fluid, subjecting the shear coupling to corrosion, which can substantially affect the shear characteristics. Several of the known and most widely used shear couplings incorporate a number of shear-pins inserted in holes drilled transversely into the shear coupling. When those pins shear, parts of them may fall onto the pump and cause problems in freeing the pump.

### SUMMARY OF THE INVENTION

It is a principal object of this invention to provide an improved shear coupling for use in oil wells with sucker rods, or for use with fishing tools.

A shear coupling according to this invention is a single part; unlike any other known shear couplings. In the preferred embodiment, one end of the coupling has a pin incorporating an externally threaded head and the other end has an internally threaded cavity and a cylindrical hollow body joining both ends. Said body is weakened by the groove, providing a stress concentration point, where the coupling will part, when exposed to predetermined desired load. The main advantages of this invention, compared with the prior art, are its simplicity and relatively low cost of manufacturing. It should be understood that the stress concentration point may be provided by many different ways, all of which involve the removal of metal from the part of the body of the shear coupling situated between threaded ends of said shear coupling. Therefore, this invention should not be limited to preferred embodiment with the groove only.

Unlike some of the known shear couplings, the shear coupling according to this invention is suitable for installation with both the reciprocating and the progressive cavity pumps. Because the stress concentrating area is provided on a large diameter cylindrical body of the said coupling, as compare to some known shear couplings where it is located on a small diameter of the neck of the pin, said coupling is capable of transferring relatively large torque needed for turning the rotary pump, and for the same reason said coupling is not prone to deflection as some known shear couplings with weakened neck.

Another advantage of this invention, compare with the prior art, is the elimination of parts which could become loose after the shear coupling brakes, and could fall onto the pump and cause problems in removal of the pump. When the shear coupling according to this invention brakes, there will be only two parts, one of them attached to the sucker rod and the other part attached to the pump.

Yet another advantage of this invention, compare with the prior art, is its suitability for service in the corrosive fluid. This is achieved by an anticorrosion coating (for example urethane or one of the known corrosion and wear preventing materials suitable for this purpose) on both sides of the stress concentration area of the shear coupling, where the shear coupling is supposed to separate under a predetermined load. In the preferred embodiment of the shear coupling, the coating on the outside of the shear coupling is in the groove, so it is protected from damage caused by the coupling rubbing on the well tubing, etc., and the coating inside of the coupling is not exposed to contact with anything but the fluid which may possibly penetrate in to the coupling, so there is no danger for the coating being mechanically damaged. Because the critical area of the shear coupling is protected from contact with a corrosive fluid, corrosion will not affect the shear characteristics of the shear coupling.

The shear coupling described herein may not only be used in sucker rod strings but may also be used in connection with fishing tool operations. Meaning, the shear tool of this invention could be provided in the fishing tool string, so that the fishing tool string would shear upon a predetermined stress.

### BRIEF DESCRIPTION OF THE DRAWINGS

FIG. 1 is a side view of the preferred embodiment of the shear coupling according to this invention.

FIG. 2 is a longitudinal sectional elevation of the same shear coupling.

FIG. 3 is a one of many possible alternative embodiments of the shear coupling according to this invention, with a different design of stress-concentration point.

FIG. 4 is yet another one of alternative embodiments of the shear coupling according to this invention.

FIG. 5 is an enlarged sectional longitudinal elevation of the detail A in FIG. 4. It shows three of many possible variations of the design of the stress-concentration point.

### DETAILED DESCRIPTION OF THE INVENTION

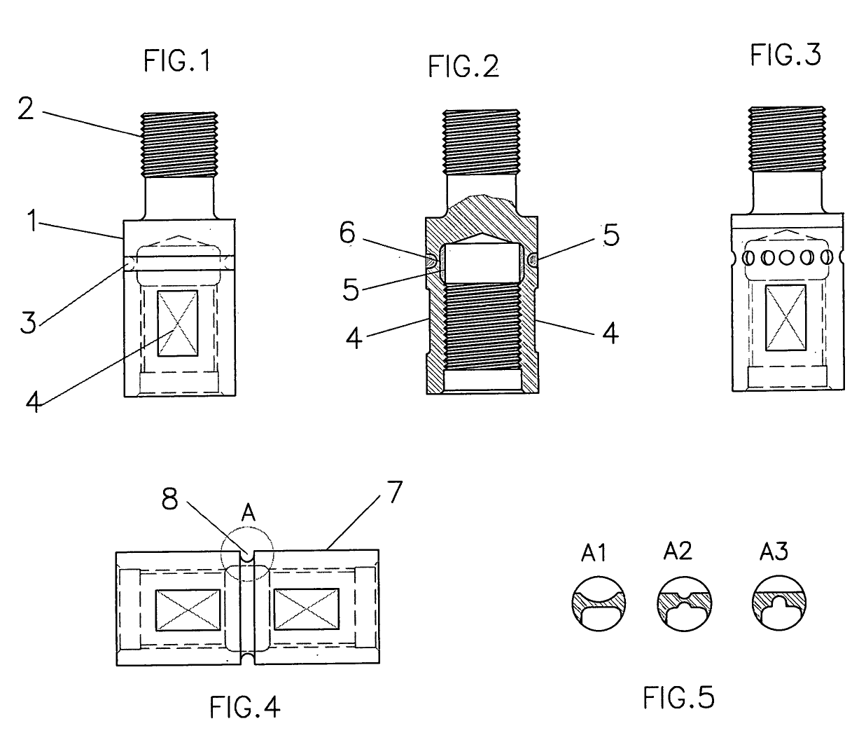

In FIG. 1, 1 is a cylindrical body of the shear coupling with an internally threaded axial bore, and 2 is an externally threaded pin. The groove 3 in the middle part of the shear coupling provides a stress-concentration point 6 (FIG. 2), which is designed to shear upon being subjected to a predetermined amount of stress. In FIGS. 1 and 2, 4 are flat faces on the shear coupling for holding the coupling with a wrench. A corrosion and wear preventing coating 5 (FIG. 2) protects both opposing sides of the groove 3. In the alternative embodiment of the shear coupling according to this invention, shown in FIG. 4, the shear coupling is an internally threaded cylinder 7 with a groove 8 located between threaded ends, shown here without protective coating. Groove 8 provides a stress-concentration point, where the shear coupling will part if exposed to a predetermined load.

Some of the many possible variations of the groove design of the stress-concentration point in the shear coupling, according to this invention, are shown in FIG. 5, where A1 shows a shallow outside groove, A2 shows two grooves opposite to each other, one on the outside and the other inside of the shear coupling, and A3 shows an alternative with only the inside groove. FIG. 3 shows an alternative embodiment of the shear coupling according to this invention, where the stress concentration point is provided by a number of openings in the cylindrical body, situated on the circumference of the body of the coupling.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A single-part shear coupling consisting of a cylindrical body with an internally threaded cavity in one end of said body and externally threaded pin on the other end of said body, a cylindrical hollow part of said body joining both said ends of the body is weakened by a groove providing a stress concentration point where the coupling will part, when exposed to a predetermined desired load.

2. A single-part shear coupling consisting of a cylindrical hollow body with an internal thread in both ends of said body, which is weakened by a groove positioned between said threaded ends of the cylinder providing a stress concentration point where the coupling will part, when exposed to a predetermined desired load.

3. A shear coupling according to claim 1 or 2, where the surface of the groove is protected by corrosion preventing coating.

4. A shear coupling according to claim 1 or 2, where the inside surface of the cylindrical body of said coupling, opposite to the outside groove, is protected by corrosion preventing coating.

5. A shear coupling according to claim 1 or 2, where the stress concentration point is provided by locally reducing the outside diameter of the body of the said coupling.

6. A shear coupling according to claim 1 or 2, where the stress concentration point is provided by locally enlarging the inside diameter of the body of the said coupling.

7. A shear coupling according to claim 1 or 2, where the stress concentration point is provided by locally reducing the outside diameter of the body of the said coupling and also locally enlarging the inside diameter of the body of the said coupling.

8. A shear coupling according to claim 1 or 2, where the stress concentration point is provided by a number of openings in the cylindrical body of the said coupling, situated on the circumference of the body of the coupling in one or more rows, oriented perpendicularly to the axle of the coupling.

9. A shear coupling according to claim 1 or 2, where the stress concentration point is provided by a number of cavities in the cylindrical body, situated on the circumference of the body of the said coupling in one or more rows, oriented perpendicularly to the axle of the coupling.
